(19) United States
(12) Patent Application Publication
(10) Pub. No.: US 2010/0006121 A1
(43) Pub. Date: Jan. 14, 2010

(54) Plasma cleaning method

(75) Inventors: Robert Baxter, Edinburgh (GB); Helen Baxter, Edinburgh (GB)

Correspondence Address: EDWARDS ANGELL PALMER & DODGE LLP, P.O. BOX 55874, BOSTON, MA, 02205, US

(73) Assignee: THE UNIVERSITY COURT OF THE UNIVERSITY OF EDINBURG, EDINBURGH (GB)

(21) Appl. No.: 11/794,796

(22) PCT Filed: Jan. 25, 2006
(86) PCT No.: PCT/GB06/00247

§ 371 Date: Jul. 2, 2007

(30) Foreign Application Priority Data
Jan. 25, 2005 (GB) 0501460.0

(51) Int. Cl. B08B 6/00

(52) U.S. Cl. 134/1.1

(57) ABSTRACT

The present invention relates to an improved method for cleaning using plasma In particular, the present invention relates to the plasma cleaning and decontamination of instruments for use in medicine, dentistry and food preparation whereby the soiled item is exposed to a solvent and then to a plasma, whereby this enables excitation of water within the soil itself.

The present invention relates to an improved cleaning method utilising gas plasma. In particular, the present invention relates to the plasma cleaning and decontamination of instruments for use in medicine, dentistry and food preparation.

### BACKGROUND TO THE INVENTION

Adequate cleaning of contaminated instruments and devices is essential for safe disinfection and sterilisation. This is particularly important in the fields of medicine and dentistry, where instruments are commonly used on multiple patients and the risks of cross contamination are significant. Currently, although there are a number of systems and methods in place for sterilising instrumentation, it is becoming an increasing concern that the quality of the decontamination procedures is not appropriate to negate the risk of cross infection. This had led many practitioners to re-assess their infection control measures.

Similar concerns also exist in the area of food preparation where instruments and tools that have not been adequately cleaned are a significant infection or cross contamination risk.

The infectious disease process involves 3 main components; a host susceptible to the infection; a causative agent; and a means of entry. In many cases it is poorly cleaned instrumentation which acts as the means for entry, linking the causative agent to the host. Cleaning of instruments is a crucial infection control step designed for the removal of the bulk of the microbiological burden. Without effective cleaning, the microbiological burden that remains on instruments and equipment after a procedure contains proteins that can actually protect microbes from inactivation during disinfection and sterilisation procedures. However, currently there are no procedures in place which result in effective cleaning. In most cases there is simply a pre-wash step which removes bulk amounts of soil, followed by a sterilisation procedure. This often results in small amounts of organic matter remaining on the instrument which can be problematic even when said matter has been sterilised.

Failure to adequately remove organic soil that is derived from body tissues and body fluids can impede the effectiveness of subsequent sterilisation processes. Furthermore, remaining foreign materials can in subsequent invasive procedures, produce pyrogenic (fever inducing) reactions. Additionally, sterilisation alone is ineffective in deactivating the infective agent of prion diseases, i.e. spongiform encephalopathies such as sporadic CJD and variant CJD, or highly resistant infective agents such as bacterial or mycotic spores which may be iatrogenically transmitted from patient to patient.

To date, there have been five authenticated incidents of surgical patients suffering from undiagnosed CJD, where the reuse of instruments from these surgical procedures represents a potential risk to other patients. Four of these incidences, in the UK (Mayor, 2003), the USA (Belkin, 2003) and Australia (Zinn, 2000), have exposed individuals within a total cohort of 43 patients to the risk of sporadic CJD (sCJD). A single instance in Canada exposed individuals within a cohort of 71 patients to a risk of variant CJD (vCJD) (Tapp, 2003). The risk of iatrogenic transmission of CJD posed by neurosurgical interventions and invasive procedures involving the lymphoreticular system cannot be considered insignificant. These studies highlight the ongoing concerns about the level of residue removal that can be achieved by the types of decontamination methods currently employed and indicate that there is a need to develop more effective methods. Recent studies have suggested that a combination of protease and detergent treatments reduce TSE infectivity significantly. The infectivity of bovine spongiform encephalopathy (301V) mouse brain is reduced by a factor of 3 log doses by solution digestion with the modified subtilisin Properase (McLeod et al., 2004). Reduction of steel-bound infectivity has proved more difficult. A three-stage process involving sequential digestion with protease K, pronase digestion and denaturation with hot SDS solution has recently been evaluated by using the mouse intracerebral wire-transmission model. This has been shown to reduce infectivity bound to stainless steel substantially (Jackson et al., 2005).

One option for cleaning/sterilisation is the use of plasma cleaning methods, as these are relatively unaffected by the chemical complexity or tenacity of adhesion of the contaminants, and could be used to remove all organic deposits. Radio-frequency (RF)-generated gas plasma cleaning is most commonly associated with the electronics industry and is often used to clean contacts that require high electrical conductivity. In principle, plasma cleaning can degrade complex biomolecules completely to gaseous products without exposing the metal surfaces to high temperatures or corrosive chemicals (Sugawara et al., 1998). A plasma is a gas that becomes activated by flowing it through an area of high electrical energy. The energy will disassociate or accelerate the molecules and atoms and cause them to exist at a high energy state. Plasma typically comes in two types, chemical and physical. A physical plasma is one where atoms are accelerated in a straight line and can be used to etch a surface. A chemical plasma is where the atoms become disassociated and highly active and can then be flowed over a surface in order to react with any impurities or oxides.

Typically plasma cleaning is used either to remove oxides and reducible compounds from a surface, or to physically etch a surface. In many cases it is used in the electronics industry to clean surfaces prior to bonding or encapsulation etc. Gases typically used in plasmas can include combinations of argon, nitrogen, hydrogen, oxygen, as well as other less common gases. Importantly, most commonly used plasma equipment currently requires the use of a vacuum as the plasma is designed to be used at extremely low pressures to avoid the need for high temperatures which can damage the item to be cleaned. A basic overview of a cleaning procedure is to pre-wash the item to be cleaned to remove any macro soiling, then to dry the item fully before placing it into a plasma under vacuum. Importantly, as the plasma is created under a vacuum, it is well known to those skilled in the art that the item to be cleaned must be fully dried after the pre-wash step, as any liquid that remains will result in problems with the vacuum. Furthermore, and particularly in the case of medical and dental instruments, the vacuum is important to ensure the plasma is at a temperature low enough that it will not damage the instrument that is to be cleaned. The presence of water vapor in vacuum systems, such as those used to create plasma, is perhaps the most common of all problems that face the practitioners of vacuum technology. Most problems such as leaks or massive contamination can be dealt with on a one time or, at least, recurring basis, but water vapor remains as a daily problem to be faced with every pumpdown (see standard publications for vacuum technology for further detail of the problems water causes to vacuum systems examples of which are enclosed in Appendix 1).

It is preferable when cleaning medical and dental instruments to use machine cleaning processes which have been validated in a clinical setting and to accomplish sterilisation during or after the cleaning cycle. It is of clinical importance that the selected cleaning procedures should routinely produce satisfactory results. A variety of cleaning protocols and related apparatus have been developed for medical (and dental) instruments and devices which utilise some form of plasma cleaning. However, as mentioned previously, none of these methods are appropriate for efficient decontamination of instruments from alleged protein-based diseases such as CJD, BSE, etc.

One of these protocols is described in WO9830249. Disclosed is a method for cleaning, decontaminating, and sterilising catheters using a combination of liquid and gaseous/plasma sterilisation techniques. Angiography dye and saline are removed from the interior of the balloon and its lumen. The outer surfaces of the catheter and a guide wire lumen of the catheter are cleaned, decontaminated, and sterilised with a liquid sterilant. The liquid sterilant fills a balloon and a balloon lumen of the catheter. The liquid sterilant is retained in the balloon and the lumen for a selected amount of time. Thereafter, the liquid sterilant is drained from the balloon and the balloon lumen. The filling, retaining, and draining steps are repeated until an interior of the balloon and the balloon lumen are sterilised. Residual liquid sterilant is rinsed from the interior of the balloon and the balloon lumen. The catheter is dried and then a plasma or gaseous sterilant is used to sterilise at least the outer surfaces and the guide wire lumen of the catheter.

A cleaning technique that uses an atmospheric-pressure plasma decontamination/sterilisation chamber is described in WO0074730. The apparatus is useful for decontaminating sensitive equipment and materials, such as electronics, optics and national treasures, which have been contaminated with chemical and/or biological warfare agents, such as anthrax, mustard blistering agent, VX nerve gas, and the like. The apparatus may also be used for sterilisation in the medical and food industries. In use, items to be decontaminated or sterilised are supported inside the chamber. Reactive gases containing atomic and metastable oxygen species are generated by an atmospheric-pressure plasma discharge in a He/O₂ mixture and directed into the region of these items resulting in chemical reaction between the reactive species and organic substances. This reaction typically kills and/or neutralizes the contamination without damaging most equipment and materials. The plasma gases are re-circulated through a closed-loop system to minimize the loss of helium and the possibility of escape of aerosolized harmful substances.

US2003132100 describes a sterilisation and decontamination system in which a non-thermal plasma discharge device is disposed upstream of a suspension media (e.g., a filter, electrostatic precipitator, carbon bed). The plasma discharge device generates a plasma that is emitted through apertures (e.g., capillaries or slits) in the primary dielectric. Contaminants or undesirable particulate matter present in a contaminated fluid stream and/or on objects are deactivated or reduced by the plasma generated active sterilising species. Thus, the undesirable contaminants in the fluid to be treated are first reduced during their exposure to the plasma generated active sterilising species in the plasma region of the discharge device. Furthermore, the plasma generated active sterilising species are carried downstream to suspension media and upon contact therewith deactivate the contaminants collected on the suspension media itself. Advantageously, the suspension media may be cleansed in situ. To increase the sterilisation efficiency an additive, free or carrier gas (e.g., alcohol, water, dry air) may be injected into the apertures defined in the primary dielectric. These additives increase the concentration of plasma generated active sterilising agents while reducing the by-product of generated undesirable ozone pollutants. Downstream of the filter, the fluid stream may be further treated by being exposed to a catalyst media, or additional suspension media, to further reduce the amount of undesirable particulate matter. Notably, this plasma based cleaning method introduces water into the plasma stream, but this has provided no discernable effect on the cleaning process.

None of the methods discussed thus far provide an effective, efficient or reliable method for the removal of soil from instruments. In particular, these methods do not address the issue of removal of the infective agent in prion diseases. Furthermore, the soaking or pre-soaking steps as disclosed in some of the methods discussed merely facilitate the loosening of soil and play no further part in the cleaning process. The soaking, or pre-soaking, as discussed in these methods is used only to remove superficial, visible soil and it is well known to dry an instrument fully before introducing it into a plasma.

Therefore it would be desirable to obviate or at least mitigate some of the disadvantages and drawbacks associated with the prior art.

It would also be desirable to devise a plasma-based method for cleaning and/or decontamination of instruments pertinent to medical, dental and food preparation.

For the purpose of the invention the terms ‘cleaning’ and ‘sterilisation’ are taken in their broadest contexts. Thus ‘cleaning’ also covers any decontamination procedure which involves removal of soil, and ‘sterilisation’ includes the meanings of disinfection and elimination of infectivity.

According to the present invention, to be more fully described hereinafter, the objects are achievable by use of a method comprising the steps; exposing the soiled item to a solvent; and exposing the item to a plasma whereby this enables excitation of water within the soil itself.

According to the present invention there is provided a method of removing soil from an item, suitable for use with a soiled instrument, comprising the steps;
exposing the soiled item to a solvent to solvate the soil; and
exposing the item to a plasma whilst the soil is still solvated.

The step of exposing the soil to solvent results in the solvent becoming intrinsic to the biological matter (such as proteins) contained in the soil. This intrinsic complex matrix of soil and solvent acts to change the physical properties of the soil in a manner which increases the effectiveness of the plasma cleaning process. It is thought by the inventors that the method enables excitation of water within the soil itself. This can be compared to previous methods where plasma was used for chemical etching only and related only to the outer surface of the soil. In those cases in the prior art where water is used as a pre-wash step to remove visible surface soil or is introduced into the gas stream during plasma cleaning, only the soil surface is treated, whereas the present method generates excited hydroxide radicals or OH⁻ ions within the soil matrix. Exposure can take the form of immersing the item in the solvent, or spraying the item with solvent or any other appropriate means of wetting that allows the solvent to penetrate the soil present on the item.

Preferably the solvent is water, or solvent(s) having similar volatility to water.

Alternatively the solvent is a water mixture with H₂O₂. Alternatively the solvent is an aqueous solution of higher alcohols e.g. butanols.

Alternatively the solvent is an aqueous solvent containing high boiling, organic solvents.

An example of such an alterantive solvent is an aqueous solution of dimethyl formamide (DMF). Essentially, although water is the preferred choice of solvent, any liquid vehicle that is able to actively facilitate water ingression into the soil matrix is appropriate. Desirable solvent properties therefore include having a vapour pressure close to that of water (hence the desirability of a high boiling point, which in this case hmeans close to 100° C. at normal atmospheric pressure), being a hydroxide donor, having wetting ability and having hydrogen bonding properties.

Preferably the item is a medical or dental instrument.

Preferably the item is a steel item.

Optionally the method comprises the further step of removing excess solvent from the surface of the item prior to exposing the item to a plasma.

Although superficial drying can occur this relates only to the removal of any superficial solvent that may be present. The soil itself is still “wet” when exposed to the plasma, in that the intrinsic relationship between the soil and solvent which has resulted in the properties of the soil changing is still in place.

The instrument must be exposed to the solvent for sufficient time to allow the physical changing of the soil's properties to occur, which results from the solvent penetrating the soil.

Optionally the instrument is soaked for up to 48 hours.

Preferably the instrument is exposed to plasma for at least 20 minutes.

Preferably the instrument is exposed to plasma for 1 hour.

Optionally the instrument is exposed to plasma for up to 24 hours.

Preferably the solvent comprises a source of hydroxide radicals or hydroxide ions.

Optionally the. solvent further comprises a co-solvent.

Preferably the solvent comprises water.

Optionally the solvent is hydrogen peroxide.

Preferably the plasma is generated from an oxygen/argon mixture.

Preferably the plasma is generated from an oxygen 150:argon 75 cc/min mixture.

This equates to oxygen:argon in 1:2 ratio, although any oxygen:argon mixture could likely be used.

Alternatively the plasma is generated from any oxygen:inert gas mixture.

Examples include, oxygen:neon, oxygen:nitrogen and oxygen:hydrogen.

Alternatively the plasma is generated from any oxygen:gas mixture which can include oxygen:air

Alternatively the plasma is generated from an argon:CF₄ (Carbon tetrafluoride) gas mixture.

The plasma could also be generated from a triple mixture or multi-component mixture containing any combination of gas mixtures mentioned above.

Preferably the mixture is provided at 1.0 Torr.

Preferably the mixture is provided at 0.5 Torr.

Note that the pressure can also be stated as mBar, which for this purpose can be assumed to be equivalent. It is typically necessary to work under a pressure that provides a vacuum to ensure that the plasma is generated at a temperature which will not be damaging to any items/instruments that are being cleaned.

Preferably the mixture is provided at less than standard atmospheric pressure.

Preferably the mixture is provided at 25° C.-30° C.

Preferably the mixture is provided at 25° C.

Essentially, any temperature can be used, however in order to avoid damaging instruments it is desirable to keep the temperature below 60° C. Certainly raising the temperature higher than that used for autoclaving procedures increases the risk that the instruments being cleaned will be damaged.

Optionally the plasma is generated using electromagnetic waves.

Preferably the plasma is generated using excitation at a power density of >6 mW.cm⁻³.

It is possible that power levels below this could be used, however this would result in time taken for the cleaning process to be longer and therefore commercially undesirable.

Preferably the electromagnetic waves are radio frequency (RF) waves.

Preferably the radio frequency waves are 13.56 MHz.

This is chosen as it is a commercially permitted radio frequency, however other frequencies can be used.

Alternatively the electromagnetic waves are at MW frequency.

Optionally the electromagnetic waves are microwaves.

Optionally the plasma is generated by electrical means.

Preferably the step of exposing the item to plasma is carried out at a pressure below atmospheric pressure.

Various embodiments of the present invention will now be described by way of example only, with reference to the following drawings, in which:

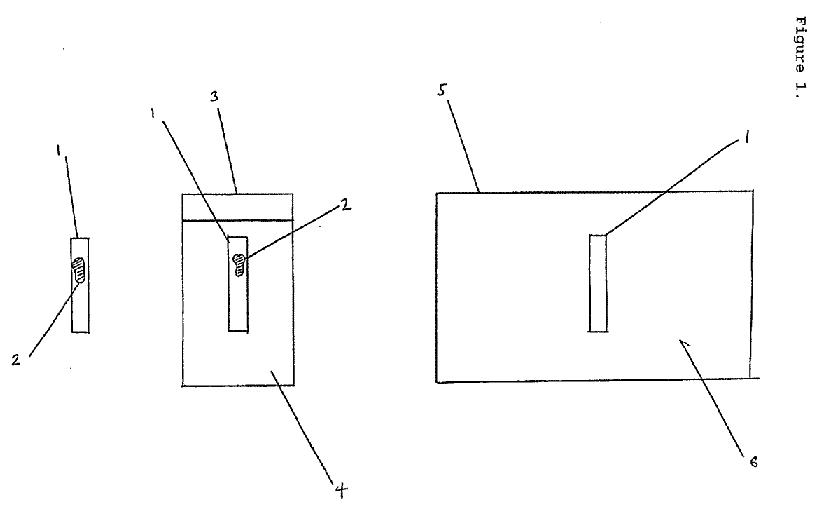

FIG. 1 is a schematic representation of an instrument being pre-soaked and then exposed to a plasma.

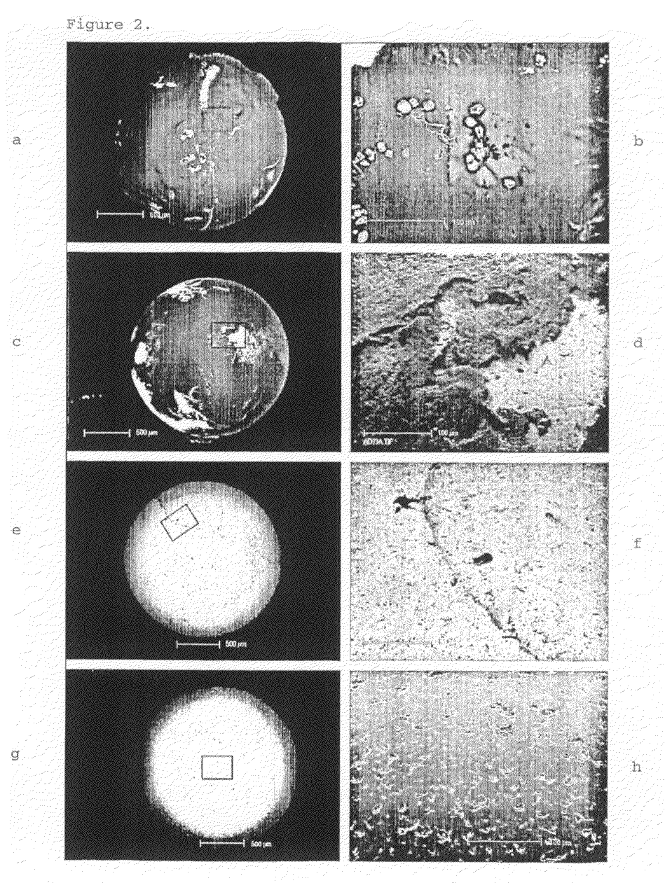

FIG. 2 shows SEM images of type 316 stainless steel spheres contaminated with brain homogenate of the 263K strain of scrapie prior to and after cleaning procedures. (a) shows a BE image of the contaminated coating on the spheres. (b) shows increased magnification of the surface of the contaminated sphere shown in (a). (c) shows a BE image of the random cleaning on a sphere that was autoclaved before washing. (d) is SE imaging showing the topography of the residual contamination in (c). (e) shows a BE image of the residual contamination on the washed sphere. (f) shows a magnified image of a 30 mm contamination spot shown in (e). (g) shows a BE image of the decontaminated surface of a sphere after RF gas-plasma treatment (procedure of the present invention). (h) shows a SE image of the decontaminated surface of the sphere shown in (g).

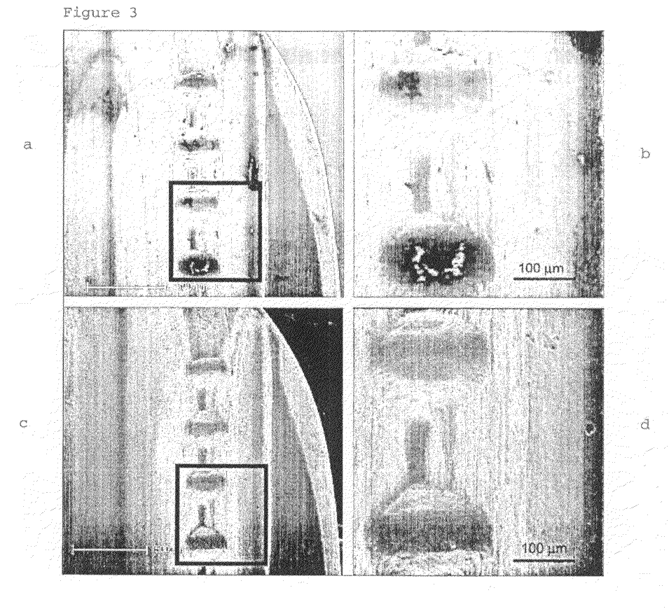

FIG. 3 shows SE images of De Bakey vascular clamps. (a) shows residual contamination adhering to the surface of the instrument. (b) shows residual organic and inorganic contamination in the range of 50-80 mm in diameter. (c, d) show decontaminated surfaces after gas-plasma treatment (procedure of the current invention).

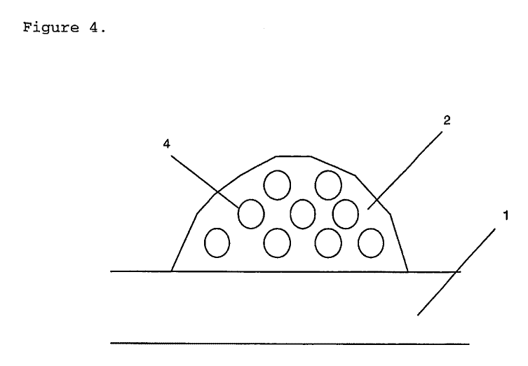

FIG. 4 is a schematic diagram indicating water ingression into the contaminant matrix on an instrument.

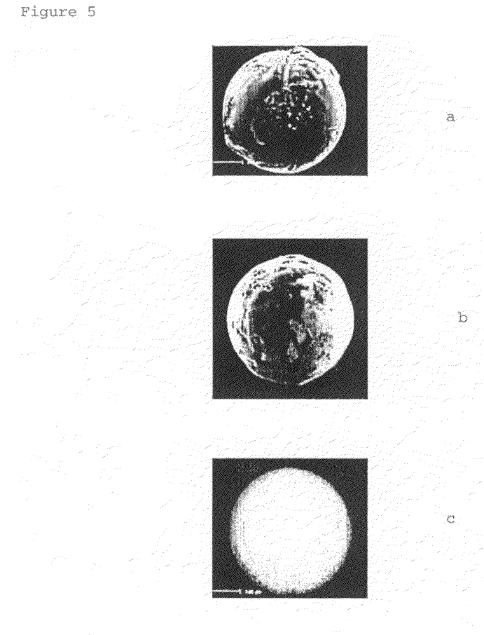

FIG. 5 shows SEM images of type stainless steel spheres with (a) dried on contamination, (b) residual contamination after being exposed to RF plasma using standard methods and (c) no contamination after being exposed to the method of the present invention.

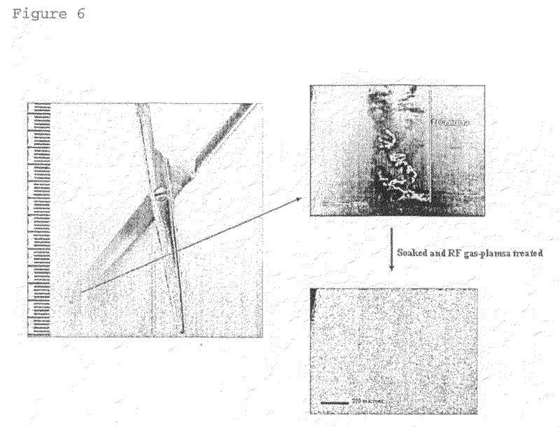

FIG. 6 shows images of a surgical instrument providing SEM images before and after cleaning by the method of the present invention.

For the purpose of the invention the terms ‘cleaning’ and ‘sterilisation’ are taken in their broadest contexts. Thus cleaning also covers any decontamination procedure which involves removal of soil and sterilisation includes the meanings of disinfection and elimination of infectivity. A plasma is taken to be an ionised gas, resulting (at any pressure) from the interaction of the gas with an alternating electric field at any frequency up to those of infra-red radiation. The term ‘medical instrument’ includes dental and veterinary instruments and, where applicable, instruments or machine parts used for handling animal produce for food preparation. The term ‘solvent’ refers to any liquid or solvating fluid, irrespective of (but including) those with associated solutes.

The plasma cleaning method is carried out as described below. An instrument 1 is soaked in sterile water in a solvent tank 3 for 30 minutes before being shaken gently to remove excess water and transferred to a plasma machine 5. Plasma 6 is generated using an oxygen 150:argon 75 cc/min mixture, at 1.0 Torr and at 25° C. (note: The unit mmHg is often called torr, particularly in vacuum applications: 760 mmHg =760 torr=1 atmosphere=standard atmospheric pressure) The mixture is subjected to a radio frequency of 13.56 MHz and excitation at a power density of >6mW.cm⁻³ for a duration of 1 hour. The instrument 1 is thus exposed to the generated plasma 6 in the plasma machine 5. The plasma 6 interacts with the soil 2 which is attached to the instrument 1, in doing so removing the soil 2. Although in the above example, the instrument 1 is soaked for 30 minutes in sterile water, it will be appreciated that it may be soaked, or pre-soaked, in any suitable solvent 4, and for any suitable length of time, that alters the physical properties of the soil 2. For example, the instrument 1 can be soaked for up 24 hours. In addition, the water may also comprise co-solvents and/or additives (such as solutes). Furthermore, whilst the plasma 6 in the above example is generated using a specified oxygen/argon mixture at specified conditions, any mixture of any materials, at any temperature and pressure, that affords the generation of a suitable plasma 6 can be used. Also, whilst in the above example the plasma 6 is generated using a specified radio frequency at a specific power density, any electromagnetic waves or electricity suitable for generating a plasma 6 can be used. The instrument 1 in the above example is exposed to the plasma 6 for 1 hour, but can be exposed for a shorter or longer period of time up to 48 hours.

To ensure that there is a change in the physical properties of the soil 2 attached to the instrument 1, it is desirable to use a solvent 4 that provides a source of hydroxyl radicals, such as water, acetone or peroxide. Importantly, the solvent 4 interacts with the soil 2 such that there is a change in the physical properties of the soil 2 before the interaction with the plasma 6. In the case of water, this interaction can be the hydration of the soil 2. In current cleaning methods, such as autoclaving, the pre-soaking stage simply provides a means for removing the visible surface soil. Other, plasma based cleaning methods have introduced water into the plasma stream, but this has provided no discernable effect on the cleaning process.

In the method described herein, after the soaking step, solvent 4 is intrinsic to the biological matter (such as proteins) contained in the soil 2 such that it changes the physical properties of the soil 2. This gives an unexpected thorough cleaning effect, capable of removing prions contained in the soil 2 (see FIG. 4).

The instrument being cleaned in the above example can be for surgical, dental or food preparation use and can be made from surgical grade metals, such as stainless steel and titanium, or plastic. However, it will be appreciated that the method as described can be used to remove soil from any article from which such removal would be desirable.

The method can be validated using stainless steel disks, which are examined by means of scanning electron microscope (SEM) images. Typically the disks are contaminated with BSA or Tissue homogenate and dried at 37° C. SEM images for verification of the efficacy of cleaning contaminated stainless steel disks indicate that the treatment using RF argon/oxygen plasma when the disk has been pre-soaked provides significantly better cleaning over methods where there is no pre-soaking.

Furthermore, surgical grade stainless steel spheres pre-contaminated with TSE infective brain tissue and then treated using the method described show that the level of contamination is reduced to below the levels that are detectable by scanning electron microscopy, spectrofluorimetric detection or biological TSE infectivity testing.

In order to test the efficiency of the method of the present invention experiments were carried out using intraperitoneally implanted stainless-steel spheres as surrogate surgical instruments, contaminated with an inoculum comprising 263K strain of scrapie, to transmit the infection by the peripheral route in hamsters. This route of infectivity transmission was elected as it is arguably more relevant to transmission during general surgical interventions than the more sensitive wire brain-implantation method, which closely mimics direct transmission by neurosurgery procedures. The gas-plasma cleaning method of the present invention was then compared with standard cleaning procedures and showed that significant reductions in infectivity could be achieved by using procedures that included a gas-plasma treatment step where the soiled item to be cleaned was hydrated and exposed to plasma.

The inoculum was prepared as a 20% (w/v) brain homogenate of the 263K strain of hamster scrapie in 0.32 M sucrose, and had a titre of 107 infectious units in 50 ml of a 1:100 dilution by the intercranial route (Kimberlin & Walker, 1978), a pH of 7.5 and a total protein concentration of 22.5 mg ml⁻¹. Pre-weighed stainless-steel spheres (type 316, 2 mm diameter; Alfa Aesar) were immersed in 20 ml volumes of freshly prepared inoculum and allowed to dry at room temperature to a constant weight for approximately 3 days. The mean weight of the homogenate dried onto the spheres was 1.1 mg.

The spheres were then separated into 4 groups and spheres in group 1 were left untreated. In group 2, the spheres were autoclaved at 137° C. for 18 min, followed by a TriGene™ disinfectant wash and then rinsed with water. In group 3, they were washed rigorously in TriGene™ disinfectant and then rinsed in water. In group 4, they were subjected to the RF gas-plasma treatment of the present invention utilising a Plasma-Etch™ PE-200 (Plasma Etch™) to create the plasma. The method of the present invention was carried out by soaking the spheres in distilled water for 30 min and, while still wet, exposing them to plasma for 1 hour, where the plasma was formed from a an Ar:O₂ mixture (at 66.7 Pa) subjected to RF excitation (13.5 MHz) at a power density of >6 mW cm⁻³. The temperature was held at 25° C.

Single spheres were implanted intraperitoneally into individual 6-week-old female hamsters by using an implant needle. Each group comprised five hamsters. The inoculated hamsters were monitored for symptoms of scrapie infection and euthanized once clinical scrapie disease was established (Marsh & Kimberlin, 1975).

FIGS. 2(a and b) shows an SEM image of a stainless-steel sphere that was contaminated experimentally with a brain homogenate of the 263K strain of scrapie and was in untreated group 1. Spheres were coated to a depth of approximately 100 mm corresponding to a mean dry-tissue weight of 1.1 mg per sphere. As expected, EDX analysis of the contamination indicated material that contained carbon, nitrogen, oxygen, sulfur, calcium and magnesium. Analysis by bioassay of the untreated 263K-contaminated spheres implanted intraperitoneally into Syrian hamsters resulted in terminal disease after 92±3 days (Table 1, group 1).

SEM images of the group 2 spheres that had been autoclaved before being washed show randomly dispersed clean patches, with large areas of residual contamination (FIGS. 2c and d). Cleaning by this method results in the most inconsistent disinfection and, consequently, the incubation period of the disease varied appreciably (202±28 days; Table 1, group 2).

Detergent washing of group 3 spheres results in only a few small areas of residual contamination remaining, each of approximately 20-30 mm in diameter (FIGS. 2e and f), and there was no transmission of disease (Table 1, group 3).

No residual contamination on the group 4 spheres treated according to the present invention could be detected by SEM (FIGS. 2g and h). EDX analysis with a detection limit of 5-6 fmol carbon (0.5 amol of a typical 30 kDa protein) within the sample volume indicated that the treatment had removed all of the experimental contamination, and analysis by bioassay showed no transmission of infectivity (Table 1, group 4).

TABLE 1
In vivo analysis of infectivity of 263K-contaminated stainless-steel
spheres before and after decontamination treatments.

| Treatment of | No. terminally | Incubation |
|---|---|---|
| contaminated | infected | Time ± SD |
| spheres | hamsters/total no. | (days) |
| Group 1: no | 5/5 | 92 ± 3 |
| decontamination | | |
| treatment | | |
| Group 2: autoclave | 5/5 | 202 ± 28 |
| followed by | | |
| detergent wash | | |
| Group 3: detergent | 0/5 | 466* |
| wash | | |
| Group 4: RF gas | 0/5 | 466* |
| plasma (present | | |
| invention) | | |

*All animals in these groups were clinically sound when euthanized at 466 days.

The method of the present invention has also been tested on reprocessed surgical instruments. These were intercepted directly after conventional cleaning and sterilization, and examined both before and after gas-plasma treatment by scanning electron microscopy (SEM) and energy-dispersive X-ray analysis (EDX).

Surgical instruments in regular use in a teaching hospital surgical unit were examined. The instruments had been cleaned stringently by conventional hospital procedures, were fully compliant with Quality Management System EN ISO 9002 and judged suitable for reuse for surgical procedures. On examination by scanning electron microscopy (SEM), out of a total of 17 randomly selected instruments from a single tray of instruments, 14 showed significant levels of contamination. A further 35 instruments were selected from random trays for detailed examination.

The gas-plasma treatment method of the present invention was carried out utilising a Plasma-Etch PE-200 (Plasma Etch) to create the plasma. The method of the present invention was carried out by soaking the SSD cleaned instruments in distilled water for 30 min and, while still wet, were exposed to plasma for 1 h, where the plasma was formed from a an Ar:O₂ (1:2) mixture (at 66.7 Pa) subjected to RF excitation (13.5 MHz) at a power density of >6 mW cm⁻³. The instrument temperature was held at 25° C.

The instruments showing the highest levels of residual contamination were all complex implements, such as De Bakey vascular clamps (Ackermann Instrumente GmbH), where residues build up in sites that are difficult to access by conventional cleaning methods. SE imaging (FIGS. 3a and b) and EDX analysis of De Bakey vascular clamps clearly showed significant areas that were contaminated by organic residues (containing carbon, nitrogen, oxygen and sulfur) and areas in the crevices and teeth of the instrument where the contamination was from both organic residues and inorganic salts (comprising sodium, calcium, magnesium and chlorine). Soaking alone did not remove any of the debris from the instrument; however, when the instrument was soaked and then subjected to the gas-plasma treatment of the present invention, both the organic and inorganic residues were removed completely (FIGS. 3c and d).

Further experimental work was carried out on contaminated stainless steel spheres (as in FIG. 5a) and/or surgical instruments which had been shown to have residual contamination (as in FIG. 6). In both cases the spheres or instruments were;

a) soaked in distilled water for 20 minutes, to hydrate the contaminating residue.

b) placed in the plasma machine either directly on the shelves or onto a glass plate on the shelves,

c) and subjected to the following plasma procedure while still wet;

An Ar:O₂ (1:2) mixture (at 0.5 Torr) was subjected to RF excitation (13.5 MHz) at a power density of >6 mW.cm⁻³ for 1 hour. The temperature was held at constant temperature of 25° C.

Tissue deposits on substrates are soaked in water, aqueous hydrogen peroxide or water-cosolvent mixtures prior to gas plasma treatment. Sufficient time is allowed for the solution to permeate the deposit matrix.

The treated tissue deposit on the substrate surface is not allowed to dry prior to gas-plasma treatment.

The results of the sphere experiment can be seen in FIG. 5. FIG. 5a shows an untreated sphere, whereas 5b shows a sphere exposed to RF plasma without having been pre-soaked. Residual contamination still can be seen on the sphere even after plasma treatment. This can be compared to 5c where the method of the present invention was used, where, surprisingly, the sphere has been entirely cleaned of contamination.

Similarly FIG. 6 also shows that medical instrumentation is effectively cleaned using the claimed invention.

The cleaning process depends on the presence of absorbed water in the deposit.

Excitation of the adsorbed water, by species formed in the gas-plasma, affords excited radicals and ions which react with and degrade the biomolecules in the tissue deposit.

The process of cleaning involves both chemical etching of the deposit by species originating in the gas-plasma and reactions induced by the species formed from the water.

In certain cases the presence of hydrogen peroxide in the soaking solution can accelerate the cleaning process. This may act to increase the concentration of reactive hydroxide radicals formed in intimate contact with the biomolecules in the deposit.

Typical cosolvents are low volatility organic water miscible compounds such as higher alcohols (e.g. n-butanol and higher homologues) or dimethylformamide.

These cosolvents may be added to aid water permeation into fatty tissue deposits.

It should be noted that the plasma cleaning method can be applied to any instrument that may be exposed to soil, and will have several applications in a variety of environments, some of which have not been mentioned explicitly herein. In particular, the plasma cleaning method will be useful in the fields of healthcare, surgery, dentistry, sterilisation, and food preparation.

Further modifications and improvements may be incorporated without departing from the scope of the invention herein intended.

1. A method of cleaning soil from an item, suitable for use with a soiled instrument, comprising the steps;
exposing the soiled item to a solvent to solvate the soil; and
exposing the item to a plasma whilst the soil is solvated.

2. A method of cleaning soil from an item as in claim 1 wherein the solvent is water.

3. A method of cleaning soil from an item as in claim 1 wherein the item is a medical or dental instrument.

4. A method of cleaning soil from an item as in claim 1 wherein the method comprises the further step of removing excess solvent from the surface of the item prior to exposing the item to a plasma.

5. A method of cleaning soil from an item as in claim 1 wherein the instrument is exposed to a plasma for at least 20 minutes.

6. A method of cleaning soil from an item as in claim 1 wherein the instrument is soaked for up to 48 hours.

7. A method of cleaning soil from an item as in claim 1 wherein the instrument is exposed to plasma for 1 hour.

8. A method of cleaning soil from an item as in claim 1 wherein the solvent comprises a source of hydroxide radicals or hydroxide ions.

9. A method of cleaning soil from an item as in claim 1 wherein the solvent further comprises a co-solvent.

10. A method of cleaning soil from an item as in claim 1 wherein the solvent comprises water.

11. A method of cleaning soil from an item as in claim 1 wherein the solvent is hydrogen peroxide.

12. A method of cleaning soil from an item as in claim 1 wherein the plasma is generated from an oxygen/argon mixture.

13. A method of cleaning soil from an item as in claim 12 wherein the plasma is generated from an oxygen 150:argon 75 cc/min mixture.

14. A method of cleaning soil from an item as in claim 1 wherein the plasma is generated at 1.0 Torr.

15. A method of cleaning soil from an item as in claim 1 wherein the plasma is generated at 25° C.

16. A method of cleaning soil from an item as in claim 1 wherein the plasma is generated using electromagnetic waves.

17. A method of cleaning soil from an item as in claim 1 wherein the plasma is generated using excitation at a power density of >6 mW.cm⁻³.

18. A method of cleaning soil from an item as in claim 16 wherein the electromagnetic waves are radio frequency (RF) waves.

19. A method of cleaning soil from an item as in claim 18 the radio frequency waves are 13.56 MHz.

20. A method of cleaning soil from an item as in claim 16 wherein the electromagnetic waves are microwaves.

21. A method of cleaning soil from an item as in claim 1 wherein the step of exposing the item to plasma is carried out at a pressure below atmospheric pressure.
